(19) United States
(12) Patent Application Publication
(10) Pub. No.: US 2026/0243053 A1
(43) Pub. Date: Aug. 20, 2026

(54) DUAL SENSOR DETECTION SYSTEM WITH LIMITED COMPUTE AND METHOD THEREOF

(71) Applicant: Deere & Company, Moline, IL (US)

(72) Inventor: Travis J. Davis, Polk City, IA (US)

(21) Appl. No.: 19/053,474

(22) Filed: Feb. 14, 2025

(51) Int. Cl. E02F 9/20; E02F 9/26; G01S 13/931

(52) U.S. Cl. CPC E02F 9/2045; E02F 9/261; G01S 13/931; G01S 2013/9318

(57) ABSTRACT

A method of detecting an object along a path of travel of a work machine includes receiving a first signal from the first low resolution sensing unit, a second signal from the second low resolution sensing unit, and a third signal from the third low resolution sensing unit. The method includes comparing the first signal, the second signal, and the third signal to a threshold, and determining an amount of throughput to assign to each of the first high resolution sensing unit, the second high resolution sensing unit, and the third high resolution sensing unit. The method further includes assigning a first amount of throughput to the first high resolution sensing unit, a second amount of throughput to the second high resolution sensing unit, and a third amount of throughput to the third high resolution sensing unit.

### FIELD OF THE DISCLOSURE

The present description relates to work machines and, in particular, to systems and methods for detecting objects around a work machine.

### BACKGROUND OF THE DISCLOSURE

Work machines, such as those in the agricultural, construction and forestry industries, perform a variety of operations. In some instances, the work machines are provided with a work implement or tool to perform a work function. As the work machine is operating to perform the work function in a given area, objects may be present that obstruct or preclude the work machine from being productive and performing the work function. Some work machines have the ability to detect objects in a work environment.

### SUMMARY

In an illustrative implementation, a method of detecting an object along a path of travel of a work machine, includes providing a control system including a controller and a plurality of sensors, the plurality of sensors including at least a first low resolution sensing unit, a first high resolution sensing unit, a second low resolution sensing unit, a second high resolution sensing unit, a third low resolution sensing unit, and a third high resolution sensing unit, wherein each of the plurality of sensors is in communication with the controller; controlling the work machine as the work machine moves along the path of travel; receiving, via the controller, a first signal from the first low resolution sensing unit, a second signal from the second low resolution sensing unit, and a third signal from the third low resolution sensing unit, wherein the first signal, second signal, and third signal are indicative of whether an object is detected by the respective low resolution sensing unit; comparing the first signal, the second signal, and the third signal to a threshold; determining via the controller, based on a result of comparing the first signal, the second signal, and the third signal to the threshold, an amount of throughput to assign to each of the first high resolution sensing unit, the second high resolution sensing unit, and the third high resolution sensing unit and a frequency of how often to assign the amount of throughput to each of the first high resolution sensing unit, the second high resolution sensing unit, and the third high resolution sensing unit; and assigning, via the controller, a first amount of throughput to the first high resolution sensing unit, a second amount of throughput to the second high resolution sensing unit, and a third amount of throughput to the third high resolution sensing unit.

In one example of this implementation, the method includes receiving, via the controller, a fourth signal from the first high resolution sensing unit, a fifth signal from the second high resolution sensing unit, and a sixth signal from the third high resolution sensing unit; and interpreting, based on which is the greatest of the first amount of throughput, second amount of throughput, and third amount of throughput, a type of objected detected by the respective first low resolution sensing unit, second low resolution sensing unit, and third low resolution sensing unit.

In a second example, the method includes receiving a work machine speed from one sensor of the plurality of sensors; comparing the work machine speed to a speed threshold; determining whether to execute a first speed algorithm or a second speed algorithm based on a result of comparing the work machine speed to a speed threshold. In a third example, the method includes wherein the controller assigns the first amount of throughput to the first high resolution sensing unit if the work machine speed exceeds the speed threshold, and the controller assigns an amount of throughput different from the first amount of throughput if the work machine speed is less than the speed threshold.

In a fourth example, the method includes receiving, via the controller, a fifth signal from another sensor of the plurality of sensors or an operator input, the fifth signal being indicative of a change in direction of the work machine; comparing the fifth signal to a direction threshold; and assigning, via the controller, a higher amount of throughput to one of the first, second and third high resolution sensing units based on a result of comparing the fifth signal to a direction threshold. In a fifth example, the method includes for a first period of time, assigning, via the controller, the first amount of throughput to the first high resolution sensing unit, the second amount of throughput to the second high resolution sensing unit, and the third amount of throughput to the third high resolution sensing unit; and after the first period of time and for a second period of time, assigning, via the controller, a fourth amount of throughput to the first high resolution sensing unit, a fifth amount of throughput to the second high resolution sensing unit, and a sixth amount of throughput to the third high resolution sensing unit.

In a sixth example, the method includes after the second period of time and for a third amount of time, assigning, via the controller, the first amount of throughput to the first high resolution sensing unit, the second amount of throughput to the second high resolution sensing unit, and the third amount of throughput to the third high resolution sensing unit. In a seventh example, the method includes after the second period of time and for a third amount of time, assigning, via the controller, a seventh amount of throughput to the first high resolution sensing unit, an eighth amount of throughput to the second high resolution sensing unit, and a ninth amount of throughput to the third high resolution sensing unit.

In an eighth example, the method includes when the first signal satisfies the threshold indicating the first low resolution sensing unit detects an object, the controller assigns more throughput to the first high resolution sensing unit; the controller receives a fourth signal from the first high resolution sensing unit; and the controller passes the fourth signal through an artificial intelligence module to differentiate a type of object detected by the first low resolution sensing unit. In a ninth example, the method includes adjusting, via the controller, the path of travel of the work machine based on the type of object.

In another implementation of the present disclosure, a method is provided for detecting an object along a path of travel of a work machine, the work machine including a controller and a plurality of sensors, the plurality of sensors including at least a first low resolution sensing unit, a first high resolution sensing unit, a second low resolution sensing unit, a second high resolution sensing unit, a third low resolution sensing unit, and a third high resolution sensing unit. The method includes controlling the work machine as the work machine moves along the path of travel; receiving, via the controller, a first signal from the first low resolution sensing unit, a second signal from the second low resolution sensing unit, and a third signal from the third low resolution sensing unit; determining if any one of the first signal, second signal, and third signal is indicative of an object being detected by the respective low resolution sensing unit; if none of the first signal, second signal, and third signal is indicative of an object being detected, then assigning a first amount of throughput to the first high resolution sensing unit, a second amount of throughput to the second high resolution sensing unit, and a third amount of throughput to the third high resolution sensing unit; and if at least one of the first signal, second signal, and third signal is indicative of an object being detected, then assigning a fourth amount of throughput to the first high resolution sensing unit, a fifth amount of throughput to the second high resolution sensing unit, and a sixth amount of throughput to the third high resolution sensing unit.

In one example of this implementation, the method includes determining which two of the first high resolution sensing unit, the second high resolution sensing unit, and the third high resolution sensing unit include the high priority high resolution sensing units. In a second example, the method includes assigning a higher amount of throughput to the high priority high resolution sensing units. In a third example, the method includes assigning a fourth amount of throughput to the first high resolution sensing unit, a fifth amount of throughput to the second high resolution sensing unit, and a sixth amount of throughput to the third high resolution sensing unit for a first period of time.

In a fourth example, the method includes after the first period of time, assigning a seventh amount of throughput to the first high resolution sensing unit, an eighth amount of throughput to the second high resolution sensing unit, and a ninth amount of throughput to the third high resolution sensing unit for a second period of time. In a fifth example, the method includes after the second period of time, assigning a tenth amount of throughput to the first high resolution sensing unit, an eleventh amount of throughput to the second high resolution sensing unit, and a twelfth amount of throughput to the third high resolution sensing unit for a third period of time.

In a further example, the method includes after the third period of time, assigning a thirteenth amount of throughput to the first high resolution sensing unit, a fourteenth amount of throughput to the second high resolution sensing unit, and a fifteenth amount of throughput to the third high resolution sensing unit for a fourth period of time. In another example, the method includes after the third period of time, assigning a fourth amount of throughput to the first high resolution sensing unit, a fifth amount of throughput to the second high resolution sensing unit, and a sixth amount of throughput to the third high resolution sensing unit for a fourth period of time.

In a further implementation of the present disclosure, a work machine configured to move along a path of travel includes a frame; at least one ground-engaging mechanism for supporting the frame, the at least one ground-engaging mechanism configured to propel the work machine along the path of travel; a controller having a memory unit and a processor; a plurality of sensors disposed in communication with the controller, the plurality of sensors including a first low resolution sensing unit, a first high resolution sensing unit, a second low resolution sensing unit, a second high resolution sensing unit, a third low resolution sensing unit, and a third high resolution sensing unit, wherein the first low resolution sensing unit and the first high resolution sensing unit are located on one side of the work machine, the second low resolution sensing unit and the second high resolution sensing unit are located on a second side of the work machine, and the third low resolution sensing unit and the third high resolution sensing unit are located on a third side of the work machine. During operation of the work machine, the controller is configured to receive a first signal from the first low resolution sensing unit, a second signal from the second low resolution sensing unit, and a third signal from the third low resolution sensing unit, wherein the first signal, second signal, and third signal are indicative of whether an object is detected by the respective low resolution sensing unit; compare a status of the first signal, the second signal, and the third signal to a threshold; determine, based on the status of the first signal, the second signal, and the third signal, an amount of throughput to assign to each of the first high resolution sensing unit, the second high resolution sensing unit, and the third high resolution sensing unit; and assign a first amount of throughput to the first high resolution sensing unit, a second amount of throughput to the second high resolution sensing unit, and a third amount of throughput to the third high resolution sensing unit.

In one example of this implementation, the work machine includes a speed sensor and a wheel angle sensor, the speed sensor configured to detect a speed of the work machine and the wheel angle sensor configured to detect a change in direction of the work machine, wherein the speed sensor and the wheel angle sensor are disposed in communication with the controller. During operation, the controller is configured to receive a fourth signal from the speed sensor and a fifth signal from the wheel angle sensor; compare the fourth signal to a speed threshold and the fifth signal to a direction threshold; and adjust an amount of throughput assigned to the first high resolution sensing unit, the second high resolution sensing unit, and the third high resolution sensing unit based on a result of comparing the fourth signal to a speed threshold and the fifth signal to a direction threshold.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side perspective view of an example of a work machine;

FIG. 2 is a schematic of a control system for controlling a work machine;

FIG. 3 is a flow diagram of a first implementation of a method of detecting obstacles in an area around a work machine;

FIG. 4 is a flow diagram of a second implementation of a method of detecting obstacles in an area around a work machine;

FIG. 5 is a flow diagram of a third implementation of a method of detecting obstacles in an area around a work machine;

FIG. 6 is a flow diagram of a fourth implementation of a method of detecting obstacles in an area around a work machine; and

FIG. 7 is a flow diagram of a fifth implementation of a method of detecting obstacles in an area around a work machine.

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

In on-highway applications such as with a passenger vehicle, service delivery truck, semi-trailer truck, etc., a sensor may be placed at a location on the vehicle to allow for object detection. For example, a passenger vehicle may include a proximity sensor located on a rear bumper thereof for detecting a presence of an object as the passenger vehicle moves in reverse. The use of sensing technologies to detect objects serves to improve safety as well as protect the moving vehicle and any objects that may be in a path of movement of the vehicle.

In work environments including those in agricultural, construction, forestry, and industrial applications, there is often more complexity with the work machinery and conventional automotive, on-high-way, and passenger vehicle technologies is often insufficient. Different work machines in these applications move differently and require different technologies to improve object detection and safety.

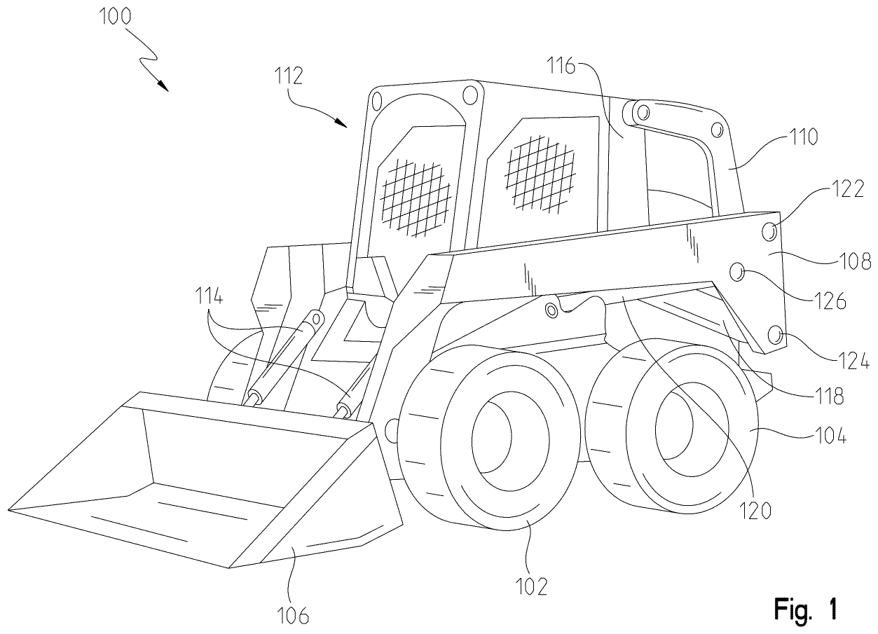

For example, referring to FIG. 1, one implementation of a work machine, such as a skid steer loader 100, is shown. This disclosure is not intended to be limited to a skid steer loader, but rather may include any agricultural, construction, or forestry work machine. The skid steer 100 can be provided with a ground-engaging mechanism for moving along the ground. In FIG. 1, the ground-engaging mechanism includes a pair of front wheels 102 and a pair of rear wheels 104. In another aspect, such as a compact track loader, the ground-engaging mechanism can be a drive track disposed on each side of the work machine. In a skid steer, the operator can manipulate controls from inside a cab 112 to drive the wheels on the right or left side of the work machine 100 at different speeds to thereby steer the work machine 100 in a desired manner. During operation, the skid steer loader can be pivoted or turned quickly as it performs a work function.

The work machine 100 can be further provided with a work implement or tool for performing a desired work function or operation. In FIG. 1, the skid steer 100 includes a loader bucket 106 for collecting material therein and transporting the material to a desired location. The loader bucket 106 can be pivotally coupled to a forward portion of a pair of boom arms 108 positioned on each side of the work machine 100. A pair of bucket tilt hydraulic actuators 114 can extend between the bucket 106 and the boom arms 108 for controlling the tilted orientation of the bucket 106 with respect to the boom arms 108. Each hydraulic actuator 114 can include a cylinder rod that actuates back and forth within a cylinder in response to a change in hydraulic pressure. By actuating the tilt hydraulic actuators 114, the operator can tilt the bucket 106 for dumping material therefrom.

In FIG. 1, the loader bucket 106 is shown at a minimum height. To raise the bucket 106, each of the pair of boom arms 108 is connected to an upper link 110 at a first location 122 and a lower link 118 at a second location 124. The upper link 110 and lower link 118 are also attached to a main frame 116 of the skid steer 100 at opposite ends of where each connects to the boom arm 108. A hydraulic actuator 120 is pivotally secured at one end to the main frame 116 and coupled to the boom arm 108 at an opposite end thereof. The hydraulic actuator 120 connects to the boom arm 108 at a third location 126.

In some applications, a single camera may be mounted to a rear of the work machine 100 to provide object detection. The single camera may be a stereo camera, for example, capable of detecting objects located along a path of movement. With more advanced work machines, however, a single camera or sensing unit may not be capable of detecting objects along the path of movement. For example, a skid steer loader often starts, stops, pivots, etc. in rapid movement. With these types of work machines, more than a single camera may be necessary. Many conventional controllers, however, are incapable of receiving input data from multiple cameras or sensing units and respond in a timely manner. In other words, many conventional controllers are unable to process adequate frames per second (throughput) from multiple feeds in parallel. A more advanced and complex computing system capable of handling higher computes or throughputs from multiple cameras or sensing units is needed. This, however, can be expensive. Moreover, a higher resolution camera or sensing unit located at each position (e.g., rear, left side, and right side) of the work machine may be able to detect objects and differentiate between a type of object (e.g., a person versus a wall or other object). The amount of compute or throughput required for the controller to receive, analyze and respond from the amount of compute or throughput may require a more advanced and expensive controller. Thus, there is a need for a controller capable of receiving compute or throughput (e.g., data, resolution, frames per second, etc.) from multiple cameras and being able to respond by controlling the work machine in a timely manner without the undue cost of expensive control systems.

In some applications, a controller or compute box may include higher levels of compute for running artificial intelligence (AI) modules and thus able to process millions of pixels in a short amount of time. In this disclosure, however, a work machine is provided with a control system including a controller having a lower compute module that is able to effectively detect objects around the work machine. The controller may be a neural network controller that has the available compute for receiving input from one of several cameras or sensing units at a higher throughput (e.g., frames per second). The controller may use other information including information about the work machine and from other sensing units to allow the controller to switch between from which sensing unit the controller receives information. In some implementations, one or more cameras or sensing units may utilize AI to provide accurate object detection. In some implementations, a controller may have lower compute in the sense the controller processes a lower throughput (e.g., 10 frames per second every 100 milliseconds). This lower throughput level of processing by the controller may be too slow of a processing speed to control the work machine that otherwise moves in multiple directions quickly.

To utilize a lower compute controller but yet still detect objects at a high frequency as a work machine moves quickly in multiple directions, an implementation of a control system 200 is provided. The control system 200 of a work machine such as the skid steer loader 100 of FIG. 1 may include a controller 202. The controller 202 includes a memory unit 204 and a processor 206. The memory unit 204 may be capable of storing algorithms, software, calibration, look-up tables, processes, etc. to be executed by the processor 206. The controller 202 may be in communication with operator inputs 208 such as controls in a cab of the work machine or from a remote device such as a mobile phone, laptop, computing system, etc. In one implementation, an operator input 208 may correspond to a travel direction or change in travel direction via a steering wheel or other control. In another implementation, an operator input may be a throttle input indicative of a speed or acceleration of the work machine.

The controller 202 may also be in communication with a display 210. The display 210 may be located in the cab of the work machine or it may be remotely located. For example, the display 210 may be on a remote device such as a mobile phone, laptop, or other computing system. The controller may receive signals from the operator input 208 and send signals to be displayed on the display 210.

The control system 200 may include at least one speed sensor 212. In one implementation, the speed sensor 212 may detect a travel speed of the work machine. The speed sensor 212 may detect rotational speed of the wheels, tracks, or other ground-engaging mechanism. In any event, the at least one speed sensor 212 may be disposed in communication with the controller 202 to provide signals indicative of the speed of the work machine.

The control system 202 may include at least one wheel angle sensor 214. The at least one wheel angle sensor 214 may detect a rotational direction of a wheel on the work machine. In some implementations, the at least one wheel angle sensor 214 may communicate a change in direction of the wheel to indicate a turn or change in travel direction of the work machine. In some implementations, the control system 200 may include a plurality of wheel angle sensors for each wheel on the work machine. In any event, the at least one wheel angle sensor 214 is disposed in communication with the controller 202.

Although not shown, the control system 200 may include other sensors such as a global-positioning sensor (GPS) unit capable of detecting location of the work machine. The GPS unit may provide a geo-positional signal indicative of the location of the work machine in a given area to the controller 202. The controller 202 may include a map such that the controller 202 may receive geo-positional coordinates of the work machine from the GPS unit, and the controller 202 may infer from the travel speed, direction and location what objects are in a work area of the work machine. In this way, the controller 202 may be able to anticipate or predict certain objects before other sensing units communicate the presence of the objects to the controller 202.

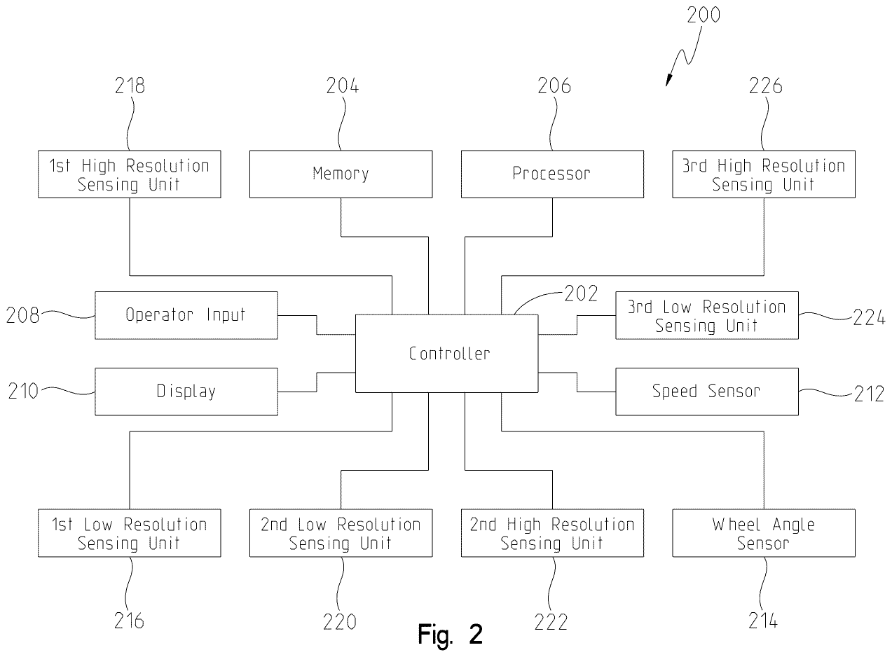

The control system 200 may include a plurality of sensing units capable of detecting objects in a defined area around the work machine. For example, in FIG. 2, the control system 200 includes a first low resolution sensing unit (1LRSU) 216, a first high resolution sensing unit (1HRSU) 218, a second low resolution sensing unit (2LRSU) 220, a second high resolution sensing unit (2HRSU) 222, a third low resolution sensing unit (3LRSU) 224, and a third high resolution sensing unit (3HRSU) 226. In some applications, the first low resolution sensing unit 216 and first high resolution sensing unit 218 may be located on a rear of the work machine. In several applications, the second low resolution sensing unit 220 and the second high resolution sensing unit 222 are located on one side of the work machine, while the third low resolution sensing unit 224 and the third high resolution sensing unit 226 are located on the opposite side of the work machine. In other implementations, a fourth or additional low resolution sensing unit and high resolution sensing unit may be located on a front of the work machine. In each implementation, each of the low and high resolution sensing units may be in communication with the controller 202.

In some implementations, a low resolution sensing unit may be an ultrasonic sensor that is capable of detecting objects along a path of travel but is unable to differentiate between object types. In other words, the low resolution sensing unit may detect a presence of the object, but there is not enough throughput, resolution or data to differentiate the type of object. In other implementations, the low resolution sensing unit may be a low resolution radar, a depth sensing unit, or any other known type of low resolution sensing unit.

In several implementations, a high resolution sensing unit may be LIDAR, a high resolution radar, or camera. In other implementations, the high resolution sensing unit may be a multi-spectral sensor, a multi-band sensor, RGB sensor or camera unit, or any other known type of high resolution sensing unit. The high resolution sensing unit may be a high perception sensor that produces a throughput, resolution or data that can be used to differentiate object type.

Depending on the application, the controller 202 may receive signals from each low resolution sensing unit and high resolution sensing unit at a given time. The controller 202 may control how much throughput, resolution or data the controller will assign to each of the respective sensing units. For purposes of this disclosure, each sensing unit communicates a signal in the form of throughput, resolution, data, frames per second, effective throughput, etc. to the controller 202. The use of the term “throughput” is intended to be general relative to the signal being generated based on a detection by the sensing unit and communicated to the controller 202. The controller 202 may receive different types of throughput from each sensing unit. For example, the controller 202 may assign a first throughput for a signal from a low resolution sensing unit such that the controller 202 is able to receive and analyze that an object is present in the direction of travel of the work machine. The controller 202, however, may not be able to differentiate the type of object that is in the direction of travel based on the first throughput. Moreover, the low resolution sensing unit may often generate false positives.

On the other hand, the controller 202 may assign a second throughput for a signal from a high resolution sensing unit such that the controller 202 is able to receive and analyze the presence of an object along the direction of travel of the work machine. In this instance, the controller 202 may also be able to differentiate the type of object detected by the high resolution sensing unit based on the second throughput. In this disclosure, the controller 202 therefore is capable of determining which throughput and assigning a certain throughput to a signal received from a sensing unit during operation.

Stated another way, the low resolution sensing unit may be an ultrasonic sensor that is capable of doing a high or first level detection of an area around the work machine. Because the ultrasonic sensor often generates false positives, the ultrasonic sensor may not be ideal or capable of detecting the type of object in the area. When the low resolution sensing unit generates a positive identification of an object, an AI compute module in the controller may switch to the high resolution sensing unit and run the signal from the high resolution sensing unit through an AI model to do a more focused detection of the area. In this way, the controller is assigning more compute or throughput to the high resolution sensing unit in comparison to the other sensing units that are in communication with the controller. In some implementations, once the low resolution sensing unit (e.g., ultrasonic sensor) no longer detects an object in the area, the controller may switch back to a primary sensing unit such as a camera. In this example, the low resolution sensing unit that originally detected the object may not be a primary sensing unit based on its location or a direction of travel of the work machine. Thus, the controller 202 may switch throughput to the primary sensing unit that may be located at a different position on the work machine. This will be described in further detail below.

Moreover, if the controller 202 determines that the work machine is moving in a different direction such as it is turning or swinging in a clockwise or counterclockwise direction. Upon detecting this change in movement of the work machine, the controller 202 may switch its throughput to a low or high resolution sensing unit located on the work machine that is capable of detecting an area along the new path of travel.

Returning to FIG. 2, in one implementation, the first low resolution sensing unit 216 and the first high resolution sensing unit 218 may be determined by the controller 202 to be high priority sensing units, whereas the second low resolution sensing unit 220, the second high resolution sensing unit 222, the third low resolution sensing unit 224, and the third high resolution sensing unit 226 may be determined by the controller 202 to be low priority sensing units. In this manner, during normal operation, the controller 202 may assign more compute or throughput to the high priority sensing units. As the work machine begins to change speed or travel direction (e.g., turn), the controller 202 may be programmed to adjust how much compute is assigned between the high priority sensing units and the low priority sensing units. As described above, an AI module in the controller 202 may be used to analyze the signal from the high resolution sensing units and differentiate the type of object being detected.

In one non-limiting example, the controller 202 may assign a first amount of compute (e.g., 10 frames per second) to the first low resolution sensing unit 216 and first high resolution sensing unit 218. At the same time, the controller 202 may assign less compute (e.g., 5 frames per second) to the other low resolution sensing units. During operation, if one of the second or third low resolution sensing units detects an object, the controller 202 receives a corresponding signal from the respective low resolution sensing unit. The controller 202 processes the signal to determine an object is present, but due to the throughput from the low resolution sensing unit, the controller 202 is unable to differentiate the type of object detected by the low resolution sensing unit. The controller 202 may therefore reassign the compute such that more compute is directed to the high resolution sensing unit (e.g., the second or third high resolution sensing unit) so that the controller 202 receives the necessary throughput from the high resolution sensing unit to identify the type of object along the path of travel.

In one implementation, the low resolution sensing unit and the high resolution sensing units located on the rear of the work machine may be referred to as primary or default sensing units, and the low resolution sensing unit and high resolution sensing unit located on each side of the work machine may be referred to as secondary sensing units. The high resolution sensing units may be AI camera units and the low resolution sensing units may be ultrasonic sensors. Other types of sensing units may be used in other implementations. In some implementations, the compute power may be split between the primary and secondary sensing units (e.g., 5 frames per second to the primary sensing unit and 5 frames per second to the secondary sensing unit).

In other implementations, the compute power may be split where more compute is given to the primary sensing unit than the secondary sensing unit until or unless the secondary sensing unit detects an object via the low resolution sensing unit or a change in driving conditions occurs (e.g., change in speed detected by speed sensor, change in direction detected by wheel angle sensor, or trigger by operator input). In this way, the controller 202 can control the different sensing units to better analyze conditions around the work machine.

In some implementations, if the work machine is turning in one direction, the controller 202 may adjust the amount of compute, for example, assigned to the rear sensing units (e.g., the first low resolution sensing unit 216 and high resolution sensing unit 218) to the first side sensing units (e.g., second low resolution sensing unit 220 and second high resolution sensing unit 222). In one non-limiting example, the controller 202 may redirect all of the compute (e.g., 10 frames per second) from the rear sensing units to the first side sensing units. Alternatively, the controller 202 may adjust so that a first percentage (e.g., 75%) of the compute is shifted for receiving and interpreting the signals from the first side sensing units and a second, lower percentage (e.g., 25%) of the compute remains assigned to signals received from the rear sensing units. In other implementations, the controller 202 may evenly split the amount of compute between the rear sensing units, the first side sensing units, and the second side sensing units (e.g., third low resolution sensing unit 224 and third high resolution sensing unit 226).

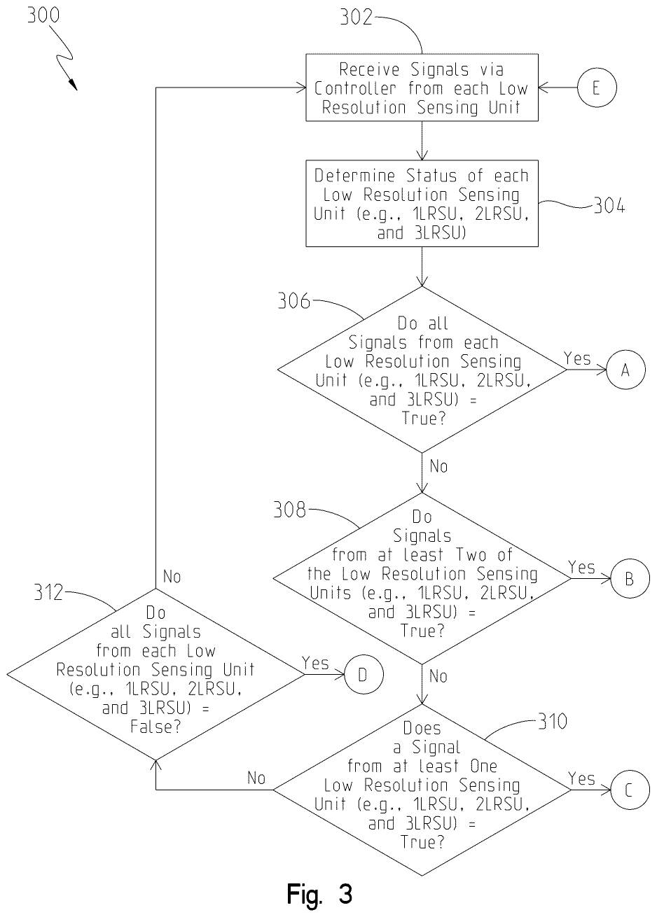

As described above, the controller 202 may include the memory unit 204 for storing software, algorithms, and/or processes that may be executable by the processor 206 to determine how to adjust compute between the various sensing units on the work machine. In FIGS. 3-7, various implementations of algorithms that are executable by the controller 202 are provided to further demonstrate the principles and teachings of the present disclosure.

Referring to FIG. 3 of the present disclosure, a first process 300 is shown. The first process 300 may be a portion of an algorithm or method executable by the controller 202 during operation of a work machine. The first process 300 may include one or more blocks that are executable by the processor 206, for example, of the controller 202. The one or more blocks may be executed in any order. In one implementation, the blocks of FIG. 3 may be executed in the order shown. In another implementation, the blocks of FIG. 3 may be executed in a different order than shown in FIG. 3. In some implementations, the process 300 may include more blocks. In other implementations, the process 300 may include fewer blocks.

In FIG. 3, the work machine is moving in a travel direction. The work machine may be moving in a work mode where the work machine performs a work function, or the work machine may be moving in a transport mode where the work machine is not performing a work function. For purposes of describing the process 300, the work machine includes the control system 202 of FIG. 2. In block 302, the controller 202 receives signals from at least each low resolution sensing unit on the work machine. For purposes of this discussion, the first low and high resolution sensing units are located on the rear of the work machine, the second low and high resolution sensing units are located on a first side of the work machine, and the third low and high resolution sensing units are located on a second side of the work machine, where the first side is opposite the second side. In some implementations, the controller 202 may also receive signals from the first high resolution sensing unit 218 on the rear of the work machine.

As the controller 202 receives signals from at least the low resolution sensing units, the process 300 advances to block 304. In block 304, the controller 202 evaluates a status of each low resolution sensing unit. For purposes of this block, the controller 202 may evaluate the status as either true or false. If true, the controller 202 determines that the signal from the corresponding sensing unit indicates an object is detected by the corresponding sensing unit. If false, the controller 202 determines that the signal from the corresponding sensing unit indicates no object is detected by the corresponding sensing unit.

Depending on the determination made by the controller 202 in block 304, the process 300 advances to either block 306, 308, 310 or 312. Alternatively, the process 300 may advance to block 306 where the controller 202 determines if all signals from the low resolution sensing units are true. If so, then process 300 advances to a first algorithm 400 to be executed by the controller 202. If not, then the process 300 advances to block 308 where the controller 202 determines if at least two of the signals from the low resolution sensing units are true. If so, then process 300 advances to a second algorithm 500 to be executed by the controller 202. If not, then the process 300 advances to block 310 where the controller 202 determines if at least one (or only one) signal from the low resolution sensing units is true. If so, then the process advances to a third algorithm 600 to be executed by the controller 202. If not, then the process 300 advances to block 312 where the controller 202 determines if the signals from each of the low resolution sensing units is false. If yes, then the process 300 advances to a fourth algorithm 700 to be executed by the controller 202. If no, then the process 300 returns to block 302.

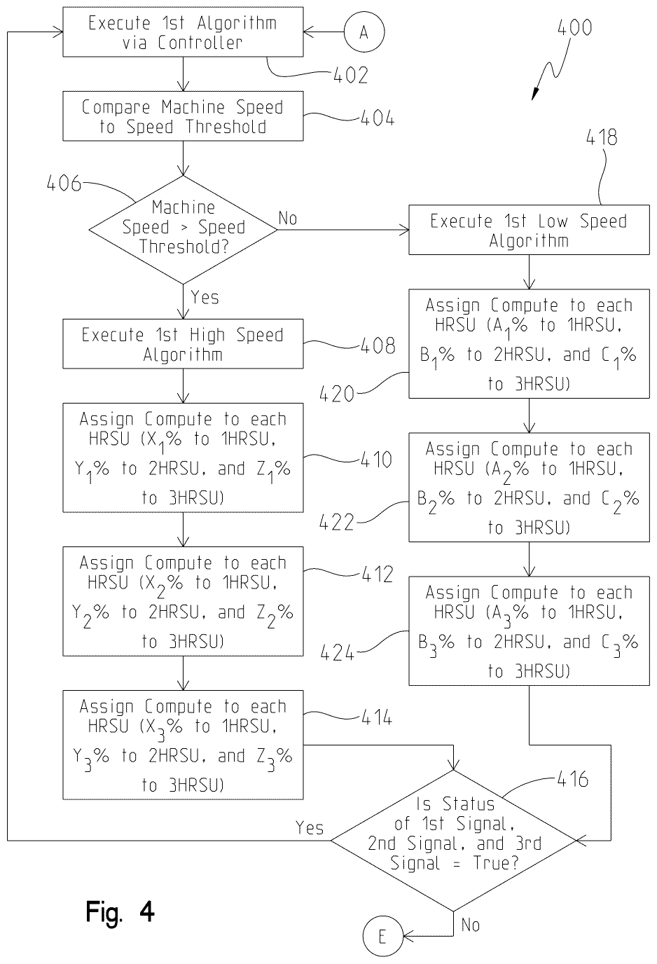

Referring to FIG. 4, one implementation of the first algorithm 400 that is executable by the controller 202 is shown. The first algorithm 400 may include one or more blocks that are executable by the processor 206, for example, of the controller 202. The one or more blocks may be executed in any order. In one implementation, the blocks of FIG. 4 may be executed in the order shown. In another implementation, the blocks of FIG. 4 may be executed in a different order than shown in FIG. 4. In some implementations, the first algorithm 400 may include more blocks. In other implementations, the first algorithm 400 may include fewer blocks.

In FIG. 4, the controller 202 begins to execute the first algorithm 400 in block 402. In block 404, the controller 202 receives a work machine speed from the speed sensor 212. The controller 202 compares the detected work machine speed to a speed threshold in blocks 404 and 406. The speed threshold may be a predefined value stored in the memory unit 204 of the controller 202. Alternatively the speed threshold may be operator defined. In any event, if the speed is greater than the speed threshold in block 406, the first algorithm 400 advances to block 408 where a first high speed algorithm is executed. If the speed is less than the speed threshold in block 406, the first algorithm 400 advances to block 418 where a first low speed algorithm is executed.

If the first high speed algorithm is executed in block 408, then the first algorithm 400 advances to block 410. In one implementation of block 410, over a first period of time, the controller 202 assigns a first amount of compute X₁ % to the first high resolution sensing unit 218, a second amount of compute Y₁ % to the second resolution sensing unit 222, and a third amount of compute Z₁ % to the third resolution sensing unit 226. For example, if the controller 202 is able to assign a maximum of 10 frames per second over a period of 5 seconds, then in one non-limiting example the controller 202 may assign 5 frames per second to the first high resolution sensing unit 218, 2.5 frames per second to the second high resolution sensing unit 222, and 2.5 frames per second to the third high resolution sensing unit 226.

Once the first period of time expires, the first algorithm 400 advances to block 412. In one implementation of block 410, over a second period of time, the controller 202 assigns a first amount of compute X₂ % to the first high resolution sensing unit 218, a second amount of compute Y₂ % to the second resolution sensing unit 222, and a third amount of compute Z₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 5 frames per second to the second high resolution sensing unit 222, and 2.5 frames per second to the third high resolution sensing unit 226.

Once the second period of time expires, the first algorithm 400 advances to block 414. In one implementation of block 414, over a third period of time, the controller 202 assigns a first amount of compute X₃ % to the first high resolution sensing unit 218, a second amount of compute Y₃ % to the second resolution sensing unit 222, and a third amount of compute Z₃ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 2.5 frames per second to the second high resolution sensing unit 222, and 5 frames per second to the third high resolution sensing unit 226.

For purposes of this disclosure, as more compute or throughput is assigned to a high resolution sensing unit, the signal from the corresponding high resolution sensing unit may be run through an AI model to do a more focused detection of the area around the machine in which the corresponding high resolution sensing unit is capable of detecting. As described previously, the controller 202 may include an AI module or the controller 202 may be in communication with a separate controller having an AI module such that the signal from the high resolution sensing unit may be run through the AI module. The AI module may include a model (AI model) which is able to receive the signal, interpret the signal, and determine the type of object being detected by the high resolution sensing unit that is in the area around the work machine.

In some implementations, the adjusting or switching of compute assigned to each high resolution sensing unit may continuously repeat so long as the status of each signal from the low resolution sensing units is true. Alternatively, once block 414 is executed, the first algorithm 400 may advance to block 416 where the controller reevaluates the status of the signals from the low resolution sensing units. If each status is true, then the first algorithm 400 returns to block 402 and the first algorithm is executed again. If each status is not true, then the first algorithm 400 terminates and the process 300 returns to block 302.

Blocks 410, 412, and 414 present one implementation of the first high speed algorithm. Other implementations are possible. For example, in another implementation, the first algorithm 400 may execute block 410, advance and execute block 412, return and execute block 410, and then advance and execute block 414. In this implementation, more compute is directed to the first high resolution sensing unit 216 located on the rear of the work machine as the controller 202 determines the first high resolution sensing unit is a higher priority than the high resolution sensing units on the sides of the work machine. This may be particularly the case if the controller 202 determines the work machine is operating in a substantially linear path in either a forward or reverse direction.

In yet other implementations, the controller 202 may adjust the timing and frequency at which the compute is adjusted between the different high resolution sensing units. The timing and frequency may be adjusted based on the speed and/or direction of the work machine.

In block 418, the first low speed algorithm may be executed by advancing to block 420. In one implementation of block 420, over a first period of time, the controller 202 assigns a first amount of compute A₁ % to the first high resolution sensing unit 218, a second amount of compute B₁ % to the second resolution sensing unit 222, and a third amount of compute C₁ % to the third resolution sensing unit 226. For example, if the controller 202 is able to assign a maximum of 10 frames per second over a period of 5 seconds, then in one non-limiting example the controller 202 may assign 5 frames per second to the first high resolution sensing unit 218, 2.5 frames per second to the second high resolution sensing unit 222, and 2.5 frames per second to the third high resolution sensing unit 226.

Once the first period of time expires, the first algorithm 400 advances to block 422. In one implementation of block 422, over a second period of time, the controller 202 assigns a first amount of compute A₂ % to the first high resolution sensing unit 218, a second amount of compute B₂ % to the second resolution sensing unit 222, and a third amount of compute C₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 5 frames per second to the second high resolution sensing unit 222, and 2.5 frames per second to the third high resolution sensing unit 226.

Once the second period of time expires, the first algorithm 400 advances to block 424. In one implementation of block 424, over a third period of time, the controller 202 assigns a first amount of compute A₃ % to the first high resolution sensing unit 218, a second amount of compute B₃ % to the second resolution sensing unit 222, and a third amount of compute C₃ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 2.5 frames per second to the second high resolution sensing unit 222, and 5 frames per second to the third high resolution sensing unit 226.

In some implementations, the adjusting of compute assigned to each high resolution sensing unit may continuously repeat so long as the status of each signal from the low resolution sensing units is true. Alternatively, once block 424 is executed, the first algorithm 400 may advance to block 416 where the controller reevaluates the status of the signals from the low resolution sensing units. If each status is true, then the first algorithm 400 returns to block 402 and the first algorithm is executed again. If each status is not true, then the first algorithm 400 terminates and the process 300 returns to block 302.

Blocks 420, 422, and 424 present one implementation of the first low speed algorithm. Other implementations are possible. For example, in another implementation, the first algorithm 400 may execute block 420, advance and execute block 422, return and execute block 420, and then advance and execute block 424. In this implementation, more compute is directed to the first high resolution sensing unit 216 located on the rear of the work machine as the controller 202 determines the first high resolution sensing unit is a higher priority than the high resolution sensing units on the sides of the work machine. This may be particularly the case if the controller 202 determines the work machine is operating in a substantially linear path in either a forward or reverse direction.

In yet other implementations, the controller 202 may adjust the timing and frequency at which the compute is adjusted between the different high resolution sensing units. The timing and frequency may be adjusted based on the speed and/or direction of the work machine.

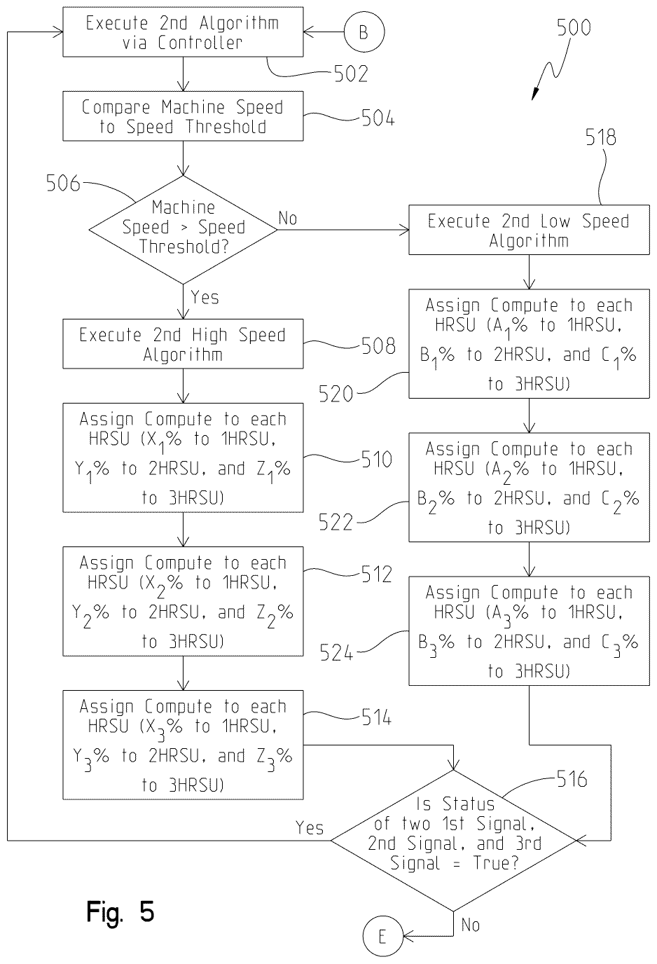

Referring to FIG. 5, one implementation of the second algorithm 500 that is executable by the controller 202 is shown. The second algorithm 500 may include one or more blocks that are executable by the processor 206, for example, of the controller 202. The one or more blocks may be executed in any order. In one implementation, the blocks of FIG. 5 may be executed in the order shown. In another implementation, the blocks of FIG. 5 may be executed in a different order than shown in FIG. 5. In some implementations, the second algorithm 500 may include more blocks. In other implementations, the second algorithm 500 may include fewer blocks.

For sake of describing the second algorithm 500, it will be assumed that the first and second low resolution sensing units 216, 220 detected an object such that the status of the signals from each of these low resolution sensing units is true and the signal corresponding to the third low resolution sensing unit 224 is false. For example, the work machine may be turning in a counterclockwise direction and the second low resolution sensing unit 220 is on the left side of the work machine where an object is detected in a field of view of the second low resolution sensing unit 220. In this example, the second low resolution sensing unit 220 may detect an object but is unable to differentiate the object. Thus, the controller 202 is configured to adjust the compute to the second high resolution sensing unit 222 which is able to detect the object and also differentiate the type of object to the controller 202.

In FIG. 5, the controller 202 begins to execute the second algorithm 500 in block 502. In block 504, the controller 202 receives a work machine speed from the speed sensor 212. The controller 202 compares the detected work machine speed to a speed threshold in blocks 504 and 506. The speed threshold may be a predefined value stored in the memory unit 204 of the controller 202. Alternatively the speed threshold may be operator defined. In any event, if the speed is greater than the speed threshold in block 506, the second algorithm 500 advances to block 508 where a second high speed algorithm is executed. If the speed is less than the speed threshold in block 506, the second algorithm 500 advances to block 518 where a second low speed algorithm is executed.

If the second high speed algorithm is executed in block 508, then the second algorithm 500 advances to block 510. In one implementation of block 510, over a first period of time, the controller 202 assigns a first amount of compute X₁ % to the first high resolution sensing unit 218, a second amount of compute Y₁ % to the second resolution sensing unit 222, and a third amount of compute Z₁ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226 (again, the third low resolution sensing unit 224 did not detect any object and its signal status is false).

Once the first period of time expires, the second algorithm 500 advances to block 512. In one implementation of block 512, over a second period of time, the controller 202 assigns a first amount of compute X₂ % to the first high resolution sensing unit 218, a second amount of compute Y₂ % to the second resolution sensing unit 222, and a third amount of compute Z₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 7.5 frames per second to the second high resolution sensing unit 222, and 0 frames per second to the third high resolution sensing unit 226.

Once the second period of time expires, the second algorithm 500 advances to block 514. In one implementation of block 514, over a third period of time, the controller 202 assigns a first amount of compute X₃ % to the first high resolution sensing unit 218, a second amount of compute Y₃ % to the second resolution sensing unit 222, and a third amount of compute Z₃ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226. In some implementations, the switching between high resolution sensing units may continuously be executed by the controller 202.

In some implementations, the adjusting of compute assigned to each high resolution sensing unit may continuously repeat so long as the status of each signal from the low resolution sensing units is true. Alternatively, once block 514 is executed, the second algorithm 500 may advance to block 516 where the controller 202 reevaluates the status of the signals from the low resolution sensing units. If the status of the first and second low resolution sensing units is true and the status of the third low resolution sensing unit is false, then the second algorithm 500 returns to block 502 and the second algorithm 500 is executed again. If the status of at least one of the low resolution sensing units changes, then the second algorithm 500 terminates and the process 300 returns to block 302.

Blocks 510, 512, and 514 present one implementation of the second high speed algorithm. Other implementations are possible. For example, in another implementation, the second algorithm 500 may execute block 510, execute block 510 again, execute block 512, and then advance and execute block 514. In this implementation, more compute is directed to the first high resolution sensing unit 216 located on the rear of the work machine as the controller 202 determines the first high resolution sensing unit 216 is a higher priority than the high resolution sensing units on the sides of the work machine. This may be particularly the case if the controller 202 determines the work machine is operating in a substantially linear path in either a forward or reverse direction.

In yet other implementations, the controller 202 may adjust the timing and frequency at which the compute is adjusted between the different high resolution sensing units. The timing and frequency may be adjusted based on the speed and/or direction of the work machine.

In block 518, the second low speed algorithm may be executed by advancing to block 520. In one implementation of block 520, over a first period of time, the controller 202 assigns a first amount of compute A₁ % to the first high resolution sensing unit 218, a second amount of compute B₁ % to the second resolution sensing unit 222, and a third amount of compute C₁ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226.

Once the first period of time expires, the second algorithm 500 advances to block 522. In one implementation of block 522, over a second period of time, the controller 202 assigns a first amount of compute A₂ % to the first high resolution sensing unit 218, a second amount of compute B₂ % to the second resolution sensing unit 222, and a third amount of compute C₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 7.5 frames per second to the second high resolution sensing unit 222, and 0 frames per second to the third high resolution sensing unit 226.

Once the second period of time expires, the second algorithm 500 advances to block 524. In one implementation of block 524, over a third period of time, the controller 202 assigns a first amount of compute A₃ % to the first high resolution sensing unit 218, a second amount of compute B₃ % to the second resolution sensing unit 222, and a third amount of compute C₃ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226. In other examples, the controller 202 may assign 10 frames per second of compute to the first high resolution sensing unit 216 in block 520, 10 frames per second of compute to the second high resolution sensing unit 220 in block 522, and 10 frames per second of compute to the first high resolution sensing unit 216 in block 524. The controller 202 may adjust the amount of compute assigned to each high resolution sensing unit as it determines during execution of the second algorithm 500 (as well as any algorithm described herein).

In some implementations, the adjusting of compute assigned to each high resolution sensing unit may continuously repeat so long as the status of the signals from the first and second low resolution sensing units is true and the status of the signal from the third low resolution sensing unit is false. Alternatively, once block 524 is executed, the second algorithm 500 may advance to block 516 where the controller reevaluates the status of the signals from the low resolution sensing units. Based on this analysis, the second algorithm 500 returns to block 502 and the second algorithm is executed again so long as one status is false and the other two statuses are true. If any one of the statuses changes, then the second algorithm 500 terminates and the process 300 returns to block 302.

Blocks 520, 522, and 524 present one implementation of the second low speed algorithm. Other implementations are possible. For example, in another implementation, the second algorithm 500 may execute block 520, advance and execute block 522, return and execute block 520, and then advance and execute block 524. In this implementation, more compute is directed to the first high resolution sensing unit 216 located on the rear of the work machine as the controller 202 determines the first high resolution sensing unit is a higher priority than the high resolution sensing units on the sides of the work machine. This may be particularly the case if the controller 202 determines the work machine is operating in a substantially linear path in either a forward or reverse direction.

In yet other implementations, the controller 202 may adjust the timing and frequency at which the compute is adjusted between the different high resolution sensing units. The timing and frequency may be adjusted based on the speed and/or direction of the work machine.

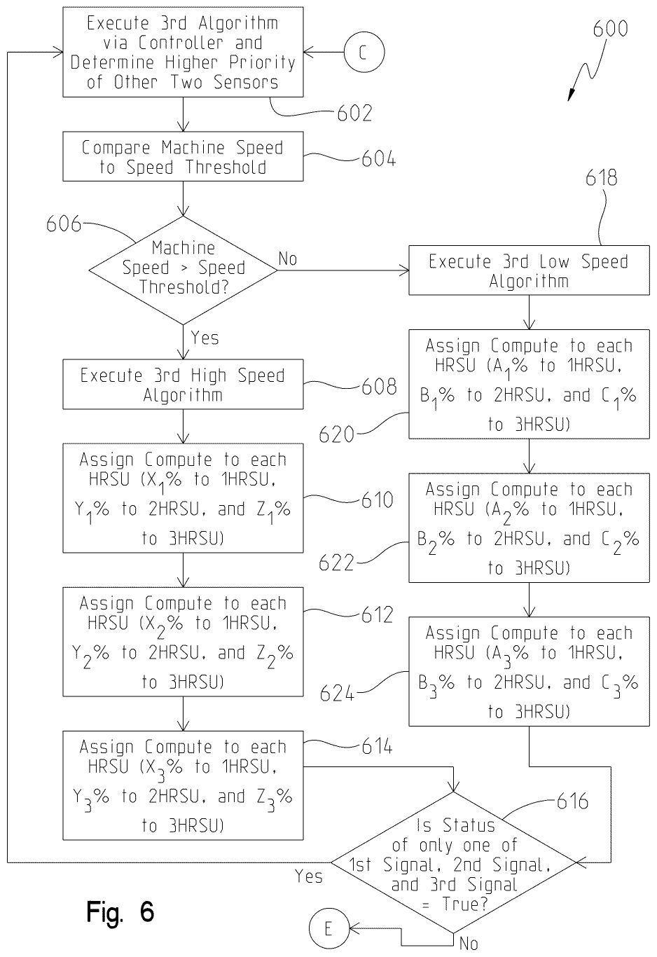

Referring to FIG. 6, one implementation of the third algorithm 600 that is executable by the controller 202 is shown. The third algorithm 600 may include one or more blocks that are executable by the processor 206, for example, of the controller 202. The one or more blocks may be executed in any order. In one implementation, the blocks of FIG. 6 may be executed in the order shown. In another implementation, the blocks of FIG. 6 may be executed in a different order than shown in FIG. 6. In some implementations, the third algorithm 600 may include more blocks. In other implementations, the third algorithm 600 may include fewer blocks.

For sake of describing the third algorithm 600, it will be assumed that one of the first and second low resolution sensing units 216, 220 detects an object such that the status of one signal from one of these low resolution sensing units is true and the status of the signals corresponding to the other low resolution sensing unit and the third low resolution sensing unit 224 are false. For example, the work machine may be operating in reverse without turning and the first low resolution sensing unit 216 on the rear of the work machine detects an object is located in a field of view of the first low resolution sensing unit 216. In this example, the first low resolution sensing unit 216 may detect an object but is unable to differentiate the object. Thus, the controller 202 is configured to adjust the compute to the first high resolution sensing unit 218 which is able to detect the object and also differentiate the type of object to the controller 202. In this instance, the controller 202 may determine the first high resolution sensing unit 218 is the highest priority sensing unit.

In another example, the work machine may be turning counterclockwise and the second low resolution sensing unit 220 on the first side of the work machine detects an object is located in a field of view thereof. In this example, the second low resolution sensing unit 220 may detect an object but is unable to differentiate the object. Thus, the controller 202 is configured to adjust the compute to the second high resolution sensing unit 222 which is able to detect the object and also differentiate the type of object to the controller 202. In this instance, the controller 202 may determine the second high resolution sensing unit 222 and the first high resolution sensing unit 218 are the highest priority sensing units. In some implementations, the controller 202 may be programmed to assume the first high resolution sensing unit 218 is always one of the two highest priority sensing units. In other implementations, the controller 202 may be configured to perform an algorithm to determine which of the high resolution sensing unis are the two highest priority sensing units.

In FIG. 6, the controller 202 begins to execute the third algorithm 600 in block 602 where it determines which two of the plurality of high resolution sensing units are the higher priority sensing units. In block 604, the controller 202 receives a work machine speed from the speed sensor 212. The controller 202 compares the detected work machine speed to a speed threshold in blocks 604 and 606. The speed threshold may be a predefined value stored in the memory unit 204 of the controller 202. Alternatively, the speed threshold may be selectively defined by the operator. In any event, if the speed is greater than the speed threshold in block 606, the third algorithm 600 advances to block 608 where a third high speed algorithm is executed. If the speed is less than the speed threshold in block 606, the third algorithm 600 advances to block 618 where a third low speed algorithm is executed.

If the third high speed algorithm is executed in block 608, then the third algorithm 600 advances to block 610. In one implementation of block 610, over a first period of time, the controller 202 assigns a first amount of compute X₁ % to the first high resolution sensing unit 218, a second amount of compute Y₁ % to the second resolution sensing unit 222, and a third amount of compute Z₁ % to the third resolution sensing unit 226. For example, if the controller 202 is able to assign a maximum of 10 frames per second over a period of 5 seconds and the first and second high resolution sensing units are the higher priority sensing units, then in one non-limiting example the controller 202 may assign 7.5 frames per second to the first high resolution sensing unit 218, 2.5 frames per second to the second high resolution sensing unit 222, and 0 frames per second to the third high resolution sensing unit 226.

Once the first period of time expires, the third algorithm 600 advances to block 612. In one implementation of block 612, over a second period of time, the controller 202 assigns a first amount of compute X₂ % to the first high resolution sensing unit 218, a second amount of compute Y₂ % to the second resolution sensing unit 222, and a third amount of compute Z₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 7.5 frames per second to the second high resolution sensing unit 222, and 0 frames per second to the third high resolution sensing unit 226.

Once the second period of time expires, the third algorithm 600 advances to block 614. In one implementation of block 614, over a third period of time, the controller 202 assigns a first amount of compute X₃ % to the first high resolution sensing unit 218, a second amount of compute Y₃ % to the second resolution sensing unit 222, and a third amount of compute Z₃ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226. In some implementations, the switching between high resolution sensing units may continuously be executed by the controller 202.

In some implementations, the adjusting of compute assigned to each high resolution sensing unit in accordance with the third algorithm 600 may continuously repeat so long as the status of only one signal from the low resolution sensing units is true. Alternatively, once block 614 is executed, the third algorithm 600 may advance to block 616 where the controller 202 reevaluates the status of the signals from the low resolution sensing units. If the status of the first, second, or third low resolution sensing units is true and the status of the other two low resolution sensing unit is false, then the third algorithm 600 returns to block 602 and the third algorithm 600 is executed again. If the status of at least one of the low resolution sensing units changes, then the third algorithm 600 terminates and the process 300 returns to block 302.

Blocks 610, 612, and 614 present one implementation of the third high speed algorithm. Other implementations are possible. For example, in another implementation, the third algorithm 600 may execute block 610, execute block 610 again, execute block 612, and then advance and execute block 614. In this implementation, more compute is directed to the first high resolution sensing unit 216 located on the rear of the work machine as the controller 202 determines the first high resolution sensing unit 216 is a higher priority than the second high resolution sensing unit on the first side of the work machine. This may be particularly the case if the controller 202 determines the work machine is operating in a substantially linear path in either a forward or reverse direction.

In yet other implementations, the controller 202 may adjust the timing and frequency at which the compute is adjusted between the different high resolution sensing units. The timing and frequency may be adjusted based on the speed and/or direction of the work machine.

In block 618, the third low speed algorithm may be executed by advancing to block 620. In one implementation of block 620, over a first period of time, the controller 202 assigns a first amount of compute A₁ % to the first high resolution sensing unit 218, a second amount of compute B₁ % to the second resolution sensing unit 222, and a third amount of compute C₁ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226.

Once the first period of time expires, the third algorithm 600 advances to block 622. In one implementation of block 622, over a second period of time, the controller 202 assigns a first amount of compute A₂ % to the first high resolution sensing unit 218, a second amount of compute B₂ % to the second resolution sensing unit 222, and a third amount of compute C₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 7.5 frames per second to the second high resolution sensing unit 222, and 0 frames per second to the third high resolution sensing unit 226.

Once the second period of time expires, the third algorithm 600 advances to block 624. In one implementation of block 624, over a third period of time, the controller 202 assigns a first amount of compute A₃ % to the first high resolution sensing unit 218, a second amount of compute B₃ % to the second resolution sensing unit 222, and a third amount of compute C₃ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226. In other examples, the controller 202 may assign 10 frames per second of compute to the first high resolution sensing unit 216 in block 620, 10 frames per second of compute to the second high resolution sensing unit 220 in block 622, and 10 frames per second of compute to the first high resolution sensing unit 216 in block 624. The controller 202 may adjust the amount of compute assigned to each high resolution sensing unit as it determines during execution of the third algorithm 600 (as well as any algorithm described herein).

In some implementations, the adjusting of compute assigned to each high resolution sensing unit may continuously repeat so long as the status of one of the signals from the first, second, and the third low resolution sensing units is true and the status of the other two signals are false. Alternatively, once block 624 is executed, the third algorithm 600 may advance to block 616 where the controller reevaluates the status of the signals from the low resolution sensing units. Based on this analysis, the third algorithm 600 returns to block 602 and the second algorithm is executed again so long as two statuses are false and the other status is true. If any one of the statuses changes, then the third algorithm 600 terminates and the process 300 returns to block 302.

Blocks 620, 622, and 624 present one implementation of the third low speed algorithm. Other implementations are possible. For example, in another implementation, the third algorithm 600 may execute block 620, advance and execute block 622, return and execute block 620, and then advance and execute block 624. In this implementation, more compute is directed to the first high resolution sensing unit 216 located on the rear of the work machine as the controller 202 determines the first high resolution sensing unit is a higher priority than the high resolution sensing units on the sides of the work machine. This may be particularly the case if the controller 202 determines the work machine is operating in a substantially linear path in either a forward or reverse direction.

In yet other implementations, the controller 202 may adjust the timing and frequency at which the compute is adjusted between the different high resolution sensing units. The timing and frequency may be adjusted based on the speed and/or direction of the work machine.

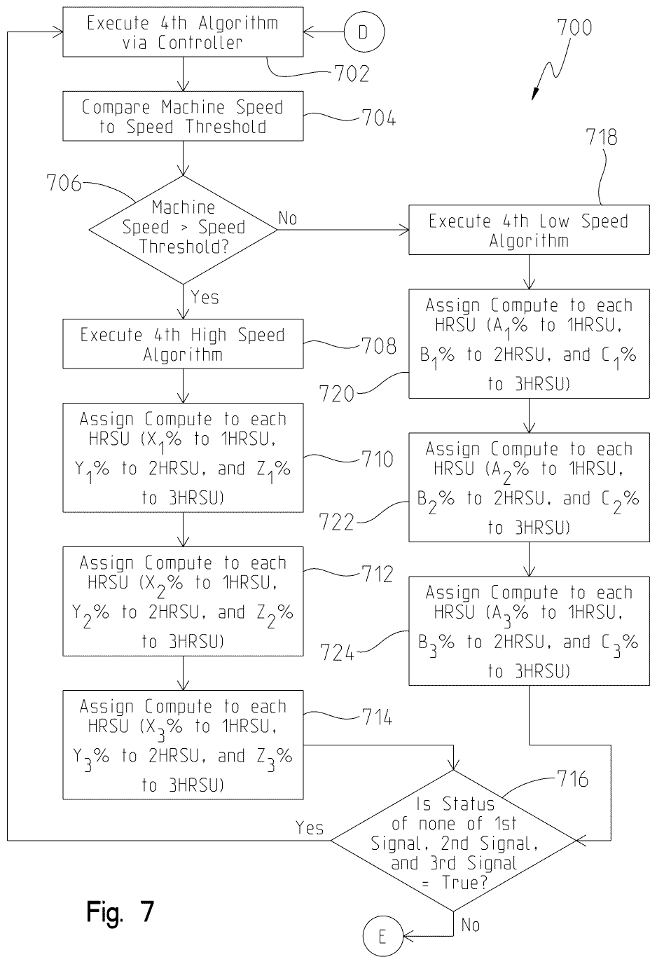

Referring to FIG. 7, one implementation of the fourth algorithm 700 that is executable by the controller 202 is shown. The fourth algorithm 700 may include one or more blocks that are executable by the processor 206, for example, of the controller 202. The one or more blocks may be executed in any order. In one implementation, the blocks of FIG. 7 may be executed in the order shown. In another implementation, the blocks of FIG. 7 may be executed in a different order than shown in FIG. 7. In some implementations, the fourth algorithm 700 may include more blocks. In other implementations, the fourth algorithm 700 may include fewer blocks.

For sake of describing the fourth algorithm 700, it will be assumed that none of the low resolution sensing units 216, 220, 224 detect an object such that the status of each signal from the low resolution sensing units is false. For example, the work machine may be operating in any direction and at any speed without an object being detected by one of the low resolution sensing units.

In one implementation of the fourth algorithm 700, the controller 202 may determine the first high resolution sensing unit 218 and one of the second high resolution sensing unit 222 and the third high resolution sensing unit 226 are the higher priority sensing units. In some implementations, the controller 202 may be programmed to assume the first high resolution sensing unit 218 is always one of the two higher priority sensing units. In other implementations, the controller 202 may be configured to perform an algorithm to determine which of the high resolution sensing unis are the two higher priority sensing units.

In FIG. 7, the controller 202 begins to execute the fourth algorithm 700 in block 702 where it determines which two of the plurality of high resolution sensing units are the higher priority sensing units. In block 704, the controller 202 receives a work machine speed from the speed sensor 212. The controller 202 compares the detected work machine speed to a speed threshold in blocks 704 and 706. The speed threshold may be a predefined value stored in the memory unit 204 of the controller 202. Alternatively, the speed threshold may be selectively defined by the operator. In any event, if the speed is greater than the speed threshold in block 706, the fourth algorithm 700 advances to block 708 where a fourth high speed algorithm is executed. If the speed is less than the speed threshold in block 706, the fourth algorithm 700 advances to block 718 where a fourth low speed algorithm is executed.

If the fourth high speed algorithm is executed in block 708, then the fourth algorithm 700 advances to block 710. In one implementation of block 710, over a first period of time, the controller 202 assigns a first amount of compute X₁ % to the first high resolution sensing unit 218, a second amount of compute Y₁ % to the second resolution sensing unit 222, and a third amount of compute Z₁ % to the third resolution sensing unit 226. For example, if the controller 202 is able to assign a maximum of 10 frames per second over a period of 5 seconds and the first and second high resolution sensing units are the higher priority sensing units, then in one non-limiting example the controller 202 may assign 7.5 frames per second to the first high resolution sensing unit 218, 2.5 frames per second to the second high resolution sensing unit 222, and 0 frames per second to the third high resolution sensing unit 226.

Once the first period of time expires, the fourth algorithm 700 advances to block 712. In one implementation of block 712, over a second period of time, the controller 202 assigns a first amount of compute X₂ % to the first high resolution sensing unit 218, a second amount of compute Y₂ % to the second resolution sensing unit 222, and a third amount of compute Z₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 7.5 frames per second to the second high resolution sensing unit 222, and 0 frames per second to the third high resolution sensing unit 226.

Once the second period of time expires, the fourth algorithm 700 advances to block 714. In one implementation of block 714, over a third period of time, the controller 202 assigns a first amount of compute X₃ % to the first high resolution sensing unit 218, a second amount of compute Y₃ % to the second resolution sensing unit 222, and a third amount of compute Z₃ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 0 frames per second to the second high resolution sensing unit 222, and 7.5 frames per second to the third high resolution sensing unit 226. In some implementations, the switching between high resolution sensing units may continuously be executed by the controller 202.

In some implementations, the adjusting of compute assigned to each high resolution sensing unit in accordance with the fourth algorithm 700 may continuously repeat so long as the status of each signal from the low resolution sensing units is false. Alternatively, once block 714 is executed, the fourth algorithm 700 may advance to block 716 where the controller 202 reevaluates the status of the signals from the low resolution sensing units. If the status of the first, second, and third low resolution sensing units is false, then the fourth algorithm 700 returns to block 702 and the fourth algorithm 700 is executed again. If the status of at least one of the low resolution sensing units changes, then the fourth algorithm 700 terminates and the process 300 returns to block 302.

Blocks 710, 712, and 714 present one implementation of the fourth high speed algorithm. Other implementations are possible. For example, in another implementation, the fourth algorithm 700 may execute block 710, execute block 710 again, execute block 712, and then advance and execute block 714. In this implementation, more compute is directed to the first high resolution sensing unit 216 located on the rear of the work machine as the controller 202 determines the first high resolution sensing unit 216 is a higher priority than the second high resolution sensing unit on the first side of the work machine and the third high resolution sensing unit on the second side thereof. This may be particularly the case if the controller 202 determines the work machine is operating in a substantially linear path in either a forward or reverse direction.

In another implementation, the controller 202 may provide an equal amount of compute to each of the high resolution sensing units. In a further implementation, the controller 202 may provide the same amount of compute to the second and third high resolution sensing units. In some implementations, the controller 202 may assign more compute to the first high resolution sensing unit than the second and third high resolution sensing units when executing the fourth algorithm 700.

In yet other implementations, the controller 202 may adjust the timing and frequency at which the compute is adjusted between the different high resolution sensing units. The timing and frequency may be adjusted based on the speed and/or direction of the work machine.

In block 718, the fourth low speed algorithm may be executed by advancing to block 720. In one implementation of block 720, over a first period of time, the controller 202 assigns a first amount of compute A₁ % to the first high resolution sensing unit 218, a second amount of compute B₁ % to the second resolution sensing unit 222, and a third amount of compute C₁ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226.

Once the first period of time expires, the fourth algorithm 700 advances to block 722. In one implementation of block 722, over a second period of time, the controller 202 assigns a first amount of compute A₂ % to the first high resolution sensing unit 218, a second amount of compute B₂ % to the second resolution sensing unit 222, and a third amount of compute C₂ % to the third resolution sensing unit 226. For example, if the controller 202 is able to assign a maximum of 10 frames per second over a period of 5 seconds, then in one non-limiting example the controller 202 may assign 2.5 frames per second to the first high resolution sensing unit 218, 7.5 frames per second to the second high resolution sensing unit 222, and 0 frames per second to the third high resolution sensing unit 226.

Once the second period of time expires, the fourth algorithm 700 advances to block 724. In one implementation of block 724, over a third period of time, the controller 202 assigns a first amount of compute A₃ % to the first high resolution sensing unit 218, a second amount of compute B₃ % to the second resolution sensing unit 222, and a third amount of compute C₃ % to the third resolution sensing unit 226. For example, if the controller 202 is able to assign a maximum of 10 frames per second over a period of 5 seconds, then in one non-limiting example the controller 202 may assign 7.5 frames per second to the first high resolution sensing unit 218, 2.5 frames per second to the second high resolution sensing unit 222, and 0 frames per second to the third high resolution sensing unit 226.

In other examples, the controller 202 may assign 10 frames per second of compute to the first high resolution sensing unit 216 in block 720, 10 frames per second of compute to the second high resolution sensing unit 220 in block 722, and 10 frames per second of compute to the first high resolution sensing unit 216 in block 724. The controller 202 may adjust the amount of compute assigned to each high resolution sensing unit as it determines during execution of the fourth algorithm 700 (as well as any algorithm described herein).

In some implementations, the adjusting of compute assigned to each high resolution sensing unit may continuously repeat so long as the status of each of the signals from the first, second, and the third low resolution sensing units is false. Alternatively, once block 724 is executed, the fourth algorithm 700 may advance to block 716 where the controller reevaluates the status of the signals from the low resolution sensing units. Based on this analysis, the fourth algorithm 700 returns to block 702 and the second algorithm is executed again so long as the status of each low resolution sensing unit is false. If any one of the statuses changes, then the fourth algorithm 700 terminates and the process 300 returns to block 302.

Blocks 720, 722, and 724 present one implementation of the fourth low speed algorithm. Other implementations are possible. For example, in another implementation, the fourth algorithm 700 may execute block 720, advance and execute block 722, return and execute block 720, and then advance and execute block 724. In this implementation, more compute is directed to the first high resolution sensing unit 216 located on the rear of the work machine as the controller 202 determines the first high resolution sensing unit is a higher priority than the high resolution sensing units on the sides of the work machine. This may be particularly the case if the controller 202 determines the work machine is operating in a substantially linear path in either a forward or reverse direction.

In yet other implementations, the controller 202 may adjust the timing and frequency at which the compute is adjusted between the different high resolution sensing units. The timing and frequency may be adjusted based on the speed and/or direction of the work machine.

While 10 frames per second is used in a general sense in the non-limiting examples above, it is to be understood other examples of frames per second may be applicable and this disclosure is not intended to be limited to any amount of compute.

Moreover, the present disclosure describes three low resolution sensing units and three high resolution sensing units. However, in some implementations, there may be fewer than three and in other implementations there may be more than three of each type of sensing unit. Thus, three low resolution sensing units and three high resolution sensing units is described herein as only one of many different arrangements of sensing units that may be used according to the principles and teachings of the present disclosure.

As described herein, a sensing unit may include any type of high or low resolution sensor. This may be a proximity sensor, a radar, a camera, a RGB camera, a mono camera, a multi-spectral camera, LIDAR, or any other known type of sensor or sensing unit capable of detecting an object along a path of travel.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 122(f) unless an element is expressly recited using the phrase “means for,” or in the case of a method claim using the phrases “operation for” or “step for.”

While the disclosure has been illustrated and described in detail in the drawings and foregoing description, such illustration and description is to be considered as exemplary and not restrictive in character, it being understood that illustrative implementation(s) have been shown and described and that all changes and modifications that come within the spirit of the disclosure are desired to be protected. It will be noted that alternative implementations of the present disclosure may not include all of the features described yet still benefit from at least some of the advantages of such features. Those of ordinary skill in the art may readily devise their own implementations that incorporate one or more of the features of the present disclosure and fall within the spirit and scope of the present disclosure as defined by the appended claims.

1. A method of detecting an object along a path of travel of a work machine, comprising:
providing a control system comprising a controller and a plurality of sensors, the plurality of sensors comprising at least a first low resolution sensing unit, a first high resolution sensing unit, a second low resolution sensing unit, a second high resolution sensing unit, a third low resolution sensing unit, and a third high resolution sensing unit, wherein each of the plurality of sensors is in communication with the controller;
controlling the work machine as the work machine moves along the path of travel;
receiving, via the controller, a first signal from the first low resolution sensing unit, a second signal from the second low resolution sensing unit, and a third signal from the third low resolution sensing unit, wherein the first signal, second signal, and third signal are indicative of whether an object is detected by the respective low resolution sensing unit;
comparing the first signal, the second signal, and the third signal to a threshold;
determining via the controller, based on a result of comparing the first signal, the second signal, and the third signal to the threshold, an amount of throughput to assign to each of the first high resolution sensing unit, the second high resolution sensing unit, and the third high resolution sensing unit and a frequency of how often to assign the amount of throughput to each of the first high resolution sensing unit, the second high resolution sensing unit, and the third high resolution sensing unit; and
assigning, via the controller, a first amount of throughput to the first high resolution sensing unit, a second amount of throughput to the second high resolution sensing unit, and a third amount of throughput to the third high resolution sensing unit.

2. The method of claim 1, further comprising:
receiving, via the controller, a fourth signal from the first high resolution sensing unit, a fifth signal from the second high resolution sensing unit, and a sixth signal from the third high resolution sensing unit; and
interpreting, based on which is the greatest of the first amount of throughput, second amount of throughput, and third amount of throughput, a type of objected detected by the respective first low resolution sensing unit, second low resolution sensing unit, and third low resolution sensing unit.

3. The method of claim 1, further comprising:
receiving a work machine speed from one sensor of the plurality of sensors;
comparing the work machine speed to a speed threshold;
determining whether to execute a first speed algorithm or a second speed algorithm based on a result of comparing the work machine speed to a speed threshold.

4. The method of claim 3, wherein the controller assigns the first amount of throughput to the first high resolution sensing unit if the work machine speed exceeds the speed threshold, and the controller assigns an amount of throughput different from the first amount of throughput if the work machine speed is less than the speed threshold.

5. The method of claim 1,
receiving, via the controller, a fifth signal from another sensor of the plurality of sensors or an operator input, the fifth signal being indicative of a change in direction of the work machine;
comparing the fifth signal to a direction threshold; and
assigning, via the controller, a higher amount of throughput to one of the first, second and third high resolution sensing units based on a result of comparing the fifth signal to a direction threshold.

6. The method of claim 1, further comprising:
for a first period of time, assigning, via the controller, the first amount of throughput to the first high resolution sensing unit, the second amount of throughput to the second high resolution sensing unit, and the third amount of throughput to the third high resolution sensing unit; and
after the first period of time and for a second period of time, assigning, via the controller, a fourth amount of throughput to the first high resolution sensing unit, a fifth amount of throughput to the second high resolution sensing unit, and a sixth amount of throughput to the third high resolution sensing unit.

7. The method of claim 6, further comprising, after the second period of time and for a third amount of time, assigning, via the controller, the first amount of throughput to the first high resolution sensing unit, the second amount of throughput to the second high resolution sensing unit, and the third amount of throughput to the third high resolution sensing unit.

8. The method of claim 6, further comprising, after the second period of time and for a third amount of time, assigning, via the controller, a seventh amount of throughput to the first high resolution sensing unit, an eighth amount of throughput to the second high resolution sensing unit, and a ninth amount of throughput to the third high resolution sensing unit.

9. The method of claim 1, further comprising:
when the first signal satisfies the threshold indicating the first low resolution sensing unit detects an object, the controller assigns more throughput to the first high resolution sensing unit;
the controller receives a fourth signal from the first high resolution sensing unit; and
the controller passes the fourth signal through an artificial intelligence module to differentiate a type of object detected by the first low resolution sensing unit.

10. The method of claim 9, further comprising adjusting, via the controller, the path of travel of the work machine based on the type of object.

11. A method of detecting an object along a path of travel of a work machine, the work machine including a controller and a plurality of sensors, the plurality of sensors comprising at least a first low resolution sensing unit, a first high resolution sensing unit, a second low resolution sensing unit, a second high resolution sensing unit, a third low resolution sensing unit, and a third high resolution sensing unit, the method comprising:
controlling the work machine as the work machine moves along the path of travel;
receiving, via the controller, a first signal from the first low resolution sensing unit, a second signal from the second low resolution sensing unit, and a third signal from the third low resolution sensing unit;
determining if any one of the first signal, second signal, and third signal is indicative of an object being detected by the respective low resolution sensing unit;
if none of the first signal, second signal, and third signal is indicative of an object being detected, then assigning a first amount of throughput to the first high resolution sensing unit, a second amount of throughput to the second high resolution sensing unit, and a third amount of throughput to the third high resolution sensing unit; and
if at least one of the first signal, second signal, and third signal is indicative of an object being detected, then assigning a fourth amount of throughput to the first high resolution sensing unit, a fifth amount of throughput to the second high resolution sensing unit, and a sixth amount of throughput to the third high resolution sensing unit.

12. The method of claim 11, further comprising determining which two of the first high resolution sensing unit, the second high resolution sensing unit, and the third high resolution sensing unit comprise the high priority high resolution sensing units.

13. The method of claim 12, further comprising assigning a higher amount of throughput to the high priority high resolution sensing units.

14. The method of claim 11, further comprising assigning a fourth amount of throughput to the first high resolution sensing unit, a fifth amount of throughput to the second high resolution sensing unit, and a sixth amount of throughput to the third high resolution sensing unit for a first period of time.

15. The method of claim 14, wherein, after the first period of time, assigning a seventh amount of throughput to the first high resolution sensing unit, an eighth amount of throughput to the second high resolution sensing unit, and a ninth amount of throughput to the third high resolution sensing unit for a second period of time.

16. The method of claim 15, wherein, after the second period of time, assigning a tenth amount of throughput to the first high resolution sensing unit, an eleventh amount of throughput to the second high resolution sensing unit, and a twelfth amount of throughput to the third high resolution sensing unit for a third period of time.

17. The method of claim 16, wherein, after the third period of time, assigning a thirteenth amount of throughput to the first high resolution sensing unit, a fourteenth amount of throughput to the second high resolution sensing unit, and a fifteenth amount of throughput to the third high resolution sensing unit for a fourth period of time.

18. The method of claim 16, wherein, after the third period of time, assigning a fourth amount of throughput to the first high resolution sensing unit, a fifth amount of throughput to the second high resolution sensing unit, and a sixth amount of throughput to the third high resolution sensing unit for a fourth period of time.

19. A work machine configured to move along a path of travel, comprising:
a frame;
at least one ground-engaging mechanism for supporting the frame, the at least one ground-engaging mechanism configured to propel the work machine along the path of travel;
a controller having a memory unit and a processor;
a plurality of sensors disposed in communication with the controller, the plurality of sensors comprising a first low resolution sensing unit, a first high resolution sensing unit, a second low resolution sensing unit, a second high resolution sensing unit, a third low resolution sensing unit, and a third high resolution sensing unit, wherein the first low resolution sensing unit and the first high resolution sensing unit are located on one side of the work machine, the second low resolution sensing unit and the second high resolution sensing unit are located on a second side of the work machine, and the third low resolution sensing unit and the third high resolution sensing unit are located on a third side of the work machine;
wherein, during operation of the work machine, the controller is configured to:
receive a first signal from the first low resolution sensing unit, a second signal from the second low resolution sensing unit, and a third signal from the third low resolution sensing unit, wherein the first signal, second signal, and third signal are indicative of whether an object is detected by the respective low resolution sensing unit;
compare a status of the first signal, the second signal, and the third signal to a threshold;
determine, based on the status of the first signal, the second signal, and the third signal, an amount of throughput to assign to each of the first high resolution sensing unit, the second high resolution sensing unit, and the third high resolution sensing unit; and
assign a first amount of throughput to the first high resolution sensing unit, a second amount of throughput to the second high resolution sensing unit, and a third amount of throughput to the third high resolution sensing unit.

20. The work machine of claim 19, further comprising a speed sensor and a wheel angle sensor, the speed sensor configured to detect a speed of the work machine and the wheel angle sensor configured to detect a change in direction of the work machine, wherein the speed sensor and the wheel angle sensor are disposed in communication with the controller;
wherein, during operation, the controller is configured to:
receive a fourth signal from the speed sensor and a fifth signal from the wheel angle sensor;
compare the fourth signal to a speed threshold and the fifth signal to a direction threshold; and
adjust an amount of throughput assigned to the first high resolution sensing unit, the second high resolution sensing unit, and the third high resolution sensing unit based on a result of comparing the fourth signal to a speed threshold and the fifth signal to a direction threshold.
